(19) United States
(12) Patent Application Publication
(10) Pub. No.: US 2012/0148253 A1
(43) Pub. Date: Jun. 14, 2012

(54) APPARATUS AND METHOD FOR PROVIDING DATA EXCHANGE SERVICE

(75) Inventors: Kyoung Ju NOH, Daejeon (KR); Yong Ki Son, Daejeon (KR); Bae Sun Kim, Daejeon (KR); Il Yeon Cho, Daejeon (KR)

(73) Assignee: Electronics and Telecommunications Research Institute, Daejeon (KR)

(21) Appl. No.: 13/209,721

(22) Filed: Aug. 15, 2011

(30) Foreign Application Priority Data
Dec. 8, 2010 (KR) 10-2010-0125118

(51) Int. Cl. H04B 10/00

(52) U.S. Cl. 398/128; 398/130

(57) ABSTRACT

Disclosed is an interface method for exchanging data among information appliances by using optical communications including visible light and information appliances supporting the same. The present invention projects a screen providing a data exchange service through a first information appliance, determines whether at least one second information appliance is positioned on the projected screen, and controls an optical communication direction of a first information appliance to exchange data with the second information appliance when the second information appliance is positioned on the projected screen so as to exchange data between the first information appliance and the second information appliance.

### CROSS-REFERENCE TO RELATED APPLICATIONS

This application claims priority to and the benefit of Korean Patent Application No. 10-2010-0125118 filed in the Korean Intellectual Property Office on Dec. 8, 2010, the entire contents of which are incorporated herein by reference.

### TECHNICAL FIELD

The present invention relates to an apparatus and a method for providing a data exchange service. More particularly, the present invention relates to an apparatus and a method for providing a data exchange service by using an optical communication.

### BACKGROUND

For information exchange in information appliances such as mobile terminals, optical communication services using an infrared ray or visible light which are advantageous in being harmless to humans and low in power consumption while communication, or relevant researches have been vitalized in recent years. However, due to characteristics of optical communications, communications are maintained only when line of sight should be necessarily ensured, and a light emitter and a light receiver needs to be present within an angle communicatable with each other. Therefore, in the related art, a user should manually place two information appliances performing data exchange at proper locations in order to provide a service by using optical communications. Further, the user should also manually operate applications in information devices in order to implement the data exchange.

### SUMMARY

The present invention has been made in an effort to provide an apparatus and a method for providing a data exchange service that provide a user intuitive interface for the data exchange and an information exchanging method based on the interface.

An exemplary embodiment of the present invention provides an apparatus for providing a data exchange service, including: a screen projecting unit projecting a screen providing a data exchange service; an information appliance's existence determining unit determining whether at least one second information appliance is positioned on the projected screen; and an optical communication direction controlling unit controlling an optical communication direction of a first information appliance to exchange data with the second information appliance when the second information appliance is positioned on the projected screen.

The information appliance's existence determining unit may include: a screen capturing portion capturing the projected screen every predetermined time; a screen processing portion performing image processing of the captured screen; and an existence determining portion determining whether the second information appliance is positioned on the image processed screen.

The optical communication direction controlling unit may adjust and control a direction of an optical transceiver mounted on the first information appliance at the time of controlling the optical communication direction of the first information appliance. The optical communication direction controlling unit may adjust and control the direction of the optical transceiver in a direction in which light intensity is the highest at the time of adjusting and controlling the direction of the optical transceiver mounted on the first information appliance.

The apparatus may further include a menu board image generating unit generating at least two types of data exchange services as a menu board type of image, and the screen projecting unit may project the generated image onto the screen. Further, the apparatus may further include an information appliance's location determining unit determining which data exchange service menu of at least two types of data exchange service menus the second information appliance is positioned on when the second information appliance is positioned on the projected screen.

The data exchange service providing apparatus may be provided in the first information appliance.

The second information appliance may include: a light sensing portion sensing light for projecting the screen; a location tracking portion tracking the location of the first information appliance outputting the sensed light; and a direction controlling portion controlling the direction of the optical transceiver to a location tracked to perform the data exchange service with the first information appliance.

Another exemplary embodiment of the present invention provides a method for providing a data exchange service, including: projecting a screen providing a data exchange service; determining whether at least one second information appliance is positioned on the projected screen; and controlling an optical communication direction of a first information appliance to exchange data with the second information appliance when the second information appliance is positioned on the projected screen.

The determining of the information appliance's existence may include: capturing the projected screen every predetermined time; performing image processing of the captured screen; and determining whether the second information appliance is positioned on the image processed screen.

In the controlling of the optical communication direction, a direction of an optical transceiver mounted on the first information appliance may be adjusted and controlled at the time of controlling the optical communication direction of the first information appliance. Further, in the controlling of the optical communication direction, the direction of the optical transceiver may be adjusted and controlled in a direction in which light intensity is the highest at the time of adjusting and controlling the direction of the optical transceiver mounted on the first information appliance.

The method may further include generating at least two types of data exchange services as a menu board type of image before the projecting of the screen, and in the projecting of the screen, the generated image may be projected onto the screen. Further, the method may further include determining which data exchange service menu of at least two types of data exchange service menus the second information appliance is positioned on when the second information appliance is positioned on the projected screen, after the generating of the menu board image.

The data exchange service providing method may be performed by the first information appliance.

The method may further include: sensing light for projecting the screen; tracking the location of the first information appliance outputting the sensed light; and controlling the direction of the optical transceiver to a location tracked to perform the data exchange service with the first information appliance, as steps performed by the second information appliances. The sensing of the light, the tracking of the location, and the controlling of the direction may be performed after the controlling of the optical communication direction.

The present invention provides a user intuitive interface for data exchange and an information exchanging method based on the interface to acquire the following effects. First, data of a type which a user desires can be exchanged through an interface to place a terminal performing data exchange at a predetermined location of a display screen. In particular, the user's desired data can be exchanged among information appliances by using optical communications. Second, the user can directly exchange data with a corresponding information appliance without creating problems adjusting locations of information appliances for data exchange based on the optical communications. Third, an environment for data exchange among the information appliances can be configured regardless of locations.

### BRIEF DESCRIPTION OF THE DRAWINGS

FIG. 1 is a schematic block diagram of an apparatus for providing a data exchange service according to an exemplary embodiment of the present invention;

FIG. 2 is a block diagram specifically showing an internal configuration of an apparatus for providing a data exchange service;

FIG. 3 is a diagram showing an exemplary service when the present invention is applied;

FIG. 4 is a diagram showing an internal constituent module of an information appliance;

FIG. 5 is a flowchart showing a method for providing a data exchange service according to an exemplary embodiment of the present invention; and

FIG. 6 is a flowchart showing data exchange among information appliances using optical communications according to an exemplary embodiment of the present invention.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the exemplary embodiment of the present invention will be described, but it will be understood to those skilled in the art that the spirit and scope of the present invention are not limited thereto and various modifications and changes can be made.

Disclosed are an interface method for exchanging data among information appliances by using optical communications including visible light and information appliances supporting the same. The present invention projects a screen providing a data exchange service through a first information appliance, determines whether at least one second information appliance is positioned on the projected screen, and controls an optical communication direction of a first information appliance to exchange data with the second information appliance when the second information appliance is positioned on the projected screen so as to exchange data between the first information appliance and the second information appliance. According to exemplary embodiments of the present invention, an environment for data exchange among the information appliances can be configured regardless of locations and a user can directly exchange data with a corresponding information appliance without a troublesome to adjusting locations of information appliances for data exchange based on the optical communications.

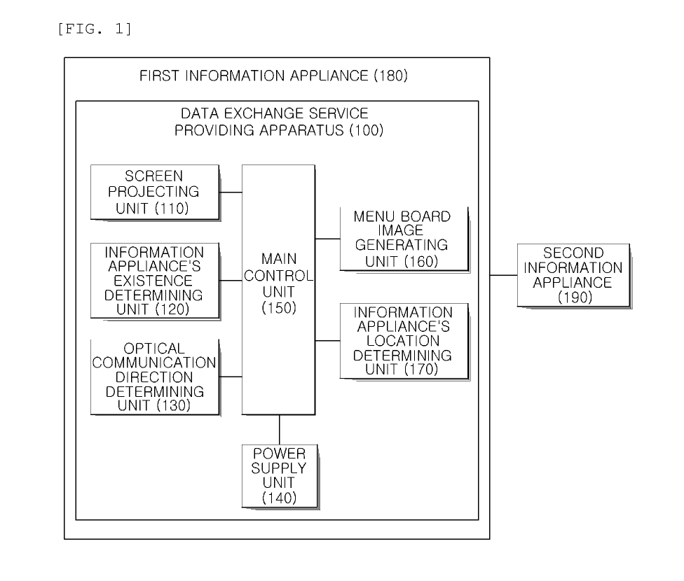

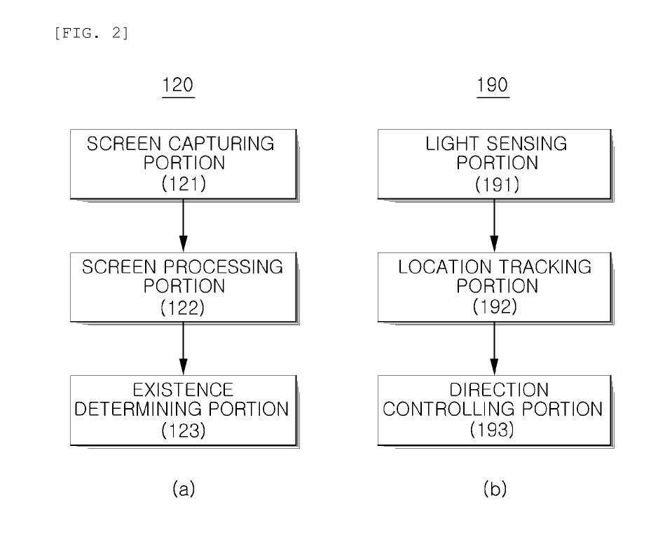

FIG. 1 is a schematic block diagram of an apparatus for providing a data exchange service according to an exemplary embodiment of the present invention. FIG. 2 is a block diagram specifically showing an internal configuration of an apparatus for providing a data exchange service. The following description refers to FIGS. 1 and 2.

Referring to FIG. 1, the data exchange service providing apparatus 100 includes a screen projecting unit 110, an information appliance's existence determining unit 120, an optical communication direction controlling unit 130, a power supply unit 140, and a main control unit 150.

The data exchange service providing apparatus 100 allows information appliances to perform a service of exchange data by using optical communications and provides an intuitive interface to a user. The data exchange service providing apparatus 100 may automatically adjust locations and directions of the information appliances through the interface without being manually operated by a user. In the exemplary embodiment, the information appliances mean various apparatuses to process or manage diverse information used in daily life. For example, the information appliances include a computer, a cellular phone, a mobile phone, a PDA, a TV, a copy machine, a facsimile, and the like. The data exchange service refers to a data exchange service among different information appliances.

The screen projecting unit 110 projects a screen providing the data exchange service. The screen projecting unit 110 may be implemented by, for example, a projector.

The information appliance's existence determining unit 120 determines whether at least one second information appliance 190 is positioned on the projected screen. To enable this, the information appliance's existence determining unit 120 may include a screen capturing portion 121, a screen processing portion 122, and an existence determining portion 123, as shown in FIG. 2A. The screen capturing portion 121 captures the projected screen every predetermined time. The screen processing portion 122 performs image processing of the captured screen. The existence determining portion 123 determines whether the second information appliance 190 is positioned on the image processed screen. The information appliance's existence determining unit 120 may be implemented by, for example, a camera.

The optical communication direction controlling unit 130 controls an optical communication direction of a first information appliance 180 to exchange data with the second information appliance 190 when the second information appliance 190 is positioned on the projected screen. The optical communication direction controlling unit 130 adjusts and controls a direction of an optical transceiver mounted on the first information appliance 180 at the time of controlling the optical communication direction of the first information appliance 180. Further, the optical communication direction controlling unit 130 adjusts and controls the direction of the optical transceiver in a direction in which light intensity is the highest, at the time of adjusting and controlling the direction of the optical transceiver mounted on the first information appliance 180. The optical communication direction controlling unit 130 may be implemented by, for example, the optical transceiver.

The power supply unit 140 supplies power to each of the units constituting the data exchange service providing apparatus 100.

The main control unit 150 controls the overall operation of each of the units constituting the data exchange service providing apparatus 100.

In the exemplary embodiment, the data exchange service may be configured in various forms. Examples of the data exchange service include the exchange of a name card, the exchange of a music file, and the like. The data exchange service providing apparatus 100 may further include a menu board image generating unit 160 by considering such a point. The menu board image generating unit 160 generates at least two types of data exchange services as an image of a menu board type. When the menu board image generating unit 160 performs such a function, the screen projecting unit 110 projects the image generated by the menu board image generating unit 160 onto the screen. Further, the data exchange service providing apparatus 100 may further include an information appliance's location determining unit 170. The information appliance's location determining unit 170 determines which data exchange service menu of at least two types of data exchange service menus the second information appliance 190 is positioned on when the second information appliance 190 is positioned on the projected screen.

In the exemplary embodiment, the data exchange service providing apparatus 100 is provided in the first information appliance 180. However, the data exchange service providing apparatus 100 is not limited thereto. Therefore, the data exchange service providing apparatus 100 may be provided separately from the first information appliance 180. Nevertheless, the data exchange service providing apparatus 100 needs to communicate with the first information appliance 180.

Meanwhile, on the assumption that the data exchange service providing apparatus 100 is provided in the first information appliance 180, the second information appliance 190 may also control the optical communication direction toward the first information appliance 180, in addition to the first information appliance 180. In the exemplary embodiment, by considering such a point, the second information appliance 190 may include a light sensing portion 191, a location tracking portion 192, and a direction controlling portion 193, as shown in FIG. 2B. The light sensing portion 191 senses light for projecting the screen. The location tracking portion 192 tracks the location of the first information appliance 180 outputting the sensed light. The direction controlling portion 193 controls the direction of the optical transceiver to a location tracked to be capable of data exchange service with the first information appliance 180.

Next, the data exchange service providing apparatus 100 will be described as an exemplary embodiment. Hereinafter, an interface type for exchanging data among an information device and information appliances using the optical communication for interchanging data will be described.

In the exemplary embodiment, in exchanging data among the information appliances including a portable device through optical communications using infrared rays or visible light, a method of removing an operation in which a user manually adjusts the location and angle of the portable device and providing an intuitive interface to the user will be proposed.

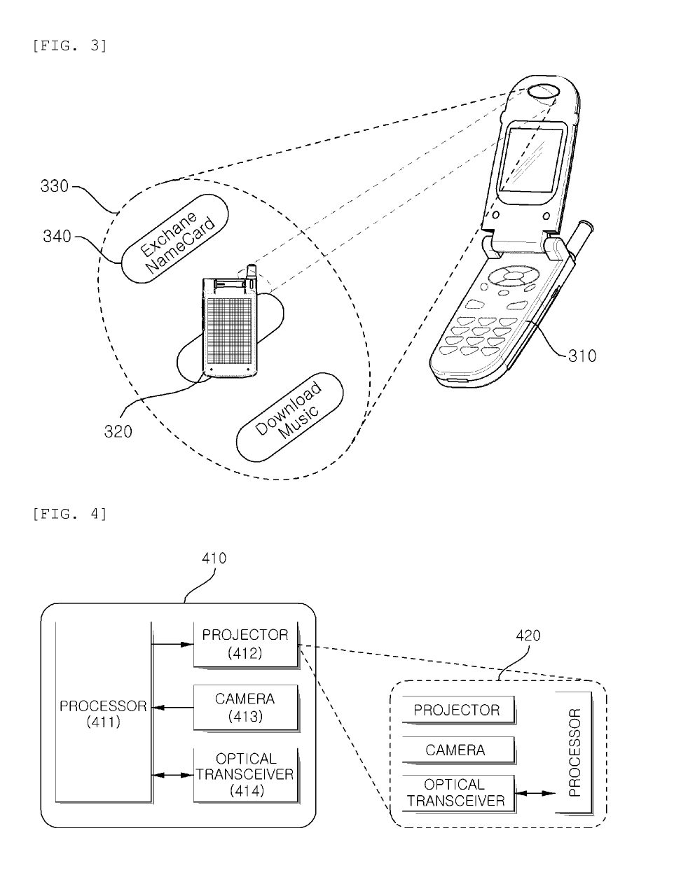

FIG. 3 is a diagram showing an exemplary service when the present invention is applied.

A user provides an initial environment for exchanging data through an initiator information appliance 310. Hereinafter, the initiator information appliance 310 is defined as the first information appliance 310 for convenience in order to being distinguished from other information appliances. The first information appliance 310 executes an application embedded by user's input and is placed at a predetermined location. In this case, the executed application refers to the application for exchanging data among the information devices. An initial menu screen 330 of the application for exchanging data through the projector that is present in the first information appliance 310 is projected onto predetermined places such as a floor, a portion on a desk, the surface of a wall. Data exchange service menus 340 are together displayed on the application menu screen 330 projected onto the predetermined place. A person who intends to exchange data with the first information appliance 310 while viewing the application screen 330 projected onto a predetermined space places the second information appliance 320 on a predetermined menu of the projected screen. Therefore, the first information appliance 310 and the second information appliance 320 exchange data with each other. For example, when the user places its own device on the menu to exchange name card among the projected screen menus, a name card stored in the first information appliance 310 and a name card stored in the second information appliance 320 are exchanged with each other.

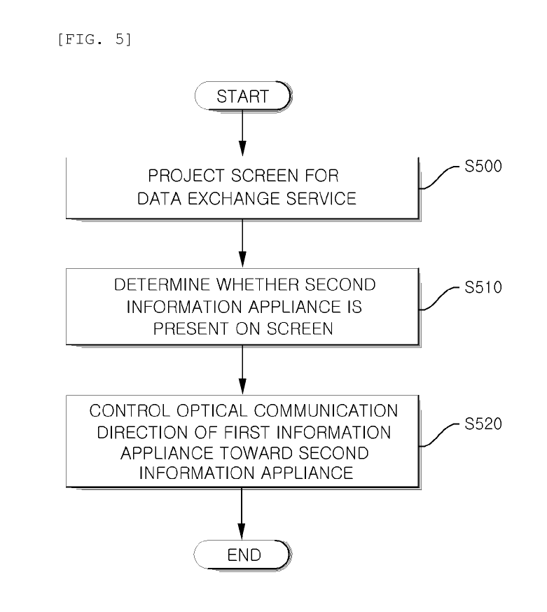

FIG. 4 is a diagram showing an internal constituent module of an information appliance. In the exemplary embodiment, the information appliance can exchange desired data by locating the information appliance at a predetermined location on the projected screen. For example, the information appliance may be implemented by a mobile device and is mounted with a processor 411, a projector 412, a camera 413, and an optical transceiver 414. When a user of an initiator information appliance 410 providing an initial environment for data exchange starts to execute an application for data exchange, a corresponding application of a corresponding device processor 411 starts to operate. The application allows a predetermined screen to be projected through its own projector module 412. Thereafter, the corresponding application in the initiator information appliance 410 captures a screen displayed through its own camera module 413 at a regular time interval and judges whether a predetermined device is present at a predetermined location of the displayed screen through image processing of the captured image. If it is verified that the predetermined device is present at the predetermined location, the application of the initiator information appliance 410 adjusts the optical transceiver module 414 to face a counterpart information appliance 420 for exchanging data corresponding to a menu of a location where a device desiring data exchange is positioned. After the direction adjusting operation of the optical transceiver module 414 of the initiator information appliance 410 is completed, the initiator information appliance 410 performs exchange of a desired type of data through the optical transceiver module of the counterpart information appliance 420 through its own optical transceiver module 414.

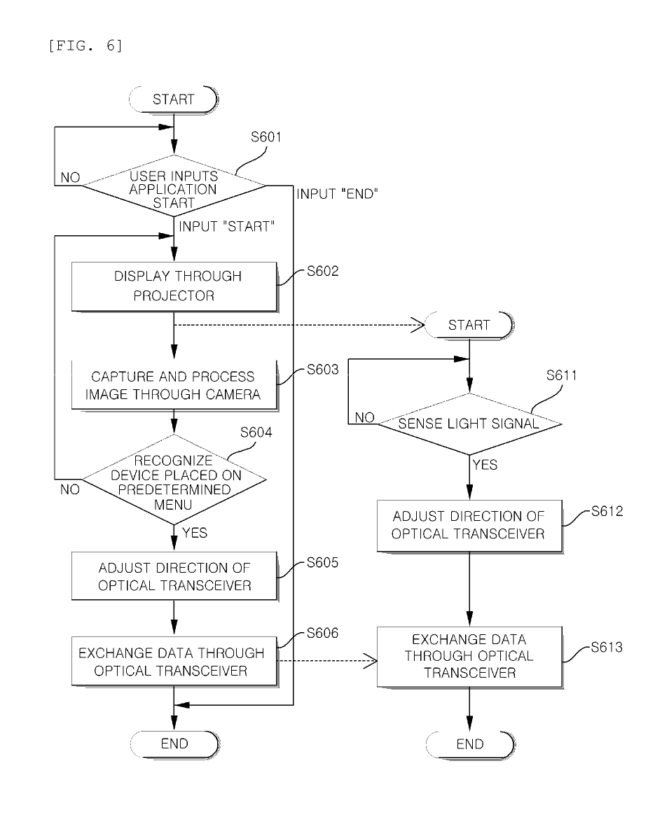

Next, a data exchange service providing method of the data exchange service providing apparatus 100 will be described. FIG. 5 is a flowchart showing a method for providing a data exchange service according to an exemplary embodiment of the present invention. Hereinafter, the following description refers to FIG. 5. In the exemplary embodiment, the data exchange service providing method is performed by a first information appliance, but is not particularly limited thereto.

First, a screen providing a data exchange service is projected (screen projecting step, S500).

Thereafter, it is determined whether at least one second information appliance is present on the projected screen (information appliance's existence determining step, S510). In this case, the information appliance's existence determining step (S510) may include a screen capturing step, a screen processing step, and an existence determining step. In the screen capturing step, the projected screen is captured every predetermined time. In the screen processing step, the captured screen is image-processed. In the existence determining step, it is determined whether the second information appliance is present on the image-processed screen.

Thereafter, when the second information appliance is present on the projected screen, an optical communication direction of the first information appliance that intends to exchange data with the second information appliance is controlled (optical communication direction controlling step, S520). In the optical communication direction controlling step (S520), the optical communication direction of the first information appliance is controlled by adjusting the direction of the optical transceiver mounted on the first information appliance. In the optical communication direction controlling step (S520), the direction of the optical transceiver is adjusted and controlled in a direction in which light intensity is the highest, at the time of adjusting and controlling the direction of the optical transceiver mounted on the first information appliance.

Before the screen projecting step (S500), a menu board image generating step may be performed. In the menu board image generating step, at least two types of data exchange services are generated as a menu board type of image. When the menu board image generating step is performed, the generated image is projected onto the screen in the screen projecting step (S500).

After the menu board image generating step, an information appliance's location determining step may be performed. In the information appliance's location determining step, which data exchange service menu of at least two types of data exchange service menus the second information appliance is positioned on is determined when the second information appliance is positioned on the projected screen. In the exemplary embodiment, the information appliance's location determining step may be performed together with the information appliance's existence determining step (S510). However, the information appliance's location determining step is not particularly limited thereto and may be performed between the screen projecting step (S500) and the information appliance's existence determining step (S510) or between the information appliance's existence determining step (S510) and the optical communication direction controlling step (S520).

Meanwhile, the following steps may be performed by the second information appliance. First, light for projecting the screen is sensed (light sensing step). Thereafter, a location of the first information appliance outputting the sensed light is tracked (location tracking step). Thereafter, the direction of the optical transceiver is controlled to a location tracked to be capable of data exchange service with the first information appliance (direction controlling step). The light sensing step, the location tracking step, and the direction controlling step may be performed after the optical communication direction controlling step (S520).

FIG. 6 is a flowchart showing data exchange among information appliances using optical communications according to an exemplary embodiment of the present invention. An initiator information appliance providing an initial environment for data exchange takes an instruction to initiate a corresponding application from a user (S601). The initiator information appliance projects a screen including a data exchange service menu through a projector included therein (S602). In addition, the initiator information appliance periodically captures the projected screen through its own camera and performs an image-processing of the captured screen (S603). If a counterpart information appliance for data exchange is positioned in a predetermined menu of the projected screen, the initiator information appliance finds whether the counterpart information appliance is present on the projected screen and on which menu of the screen the counterpart information appliance is present, through the captured image (S604). When the initiator information appliance determines the existence and location of the counterpart information appliance, the initiator information appliance automatically adjusts a direction of its own optical transceiver in a direction in which the counterpart information appliance for data exchange using the optical communications is present (S605). An information appliance which is placed at a predetermined location of the projected screen by the user also senses the projected light (S611) and adjusts the direction of its own optical transceiver module in the direction of the projector of the initiator information appliance (S612). In this case, as an exemplary method for adjusting the direction of the optical transceiver module in the direction of the projector of the initiator information appliance, a method of adjusting the direction of the optical transceiver module in a direction in which light intensity is the highest may be used. Through such a process, the initiator information appliance and the information appliance placed at the predetermined location of the projected screen may receive a desired type of data exchange service through the optical communications of their own optical transceiver modules of which the directions are adjusted each other (S606 and S613).

There are provided an interface method for exchanging data among information appliances by using optical communications including visible light and information appliances supporting the same. The present invention can be applied to a u-computing space collaboration system field.

The spirit of the present invention has just been exemplified. It will be appreciated by those skilled in the art that various modifications, changes, and substitutions can be made without departing from the essential characteristics of the present invention. Accordingly, the exemplary embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. An apparatus for providing a data exchange service, comprising:
a screen projecting unit projecting a screen providing the data exchange service;
an information appliance's existence determining unit determining whether at least one second information appliance is positioned on the projected screen; and
an optical communication direction controlling unit controlling an optical communication direction of a first information appliance to exchange data with the second information appliance when the second information appliance is positioned on the projected screen.

2. The apparatus of claim 1, wherein the information appliance's existence determining unit includes:
a screen capturing portion capturing the projected screen every predetermined time;
a screen processing portion performing image processing of the captured screen; and
an existence determining portion determining whether the second information appliance is positioned on the image processed screen.

3. The apparatus of claim 1, wherein the optical communication direction controlling unit adjusts and controls a direction of an optical transceiver mounted on the first information appliance at the time of controlling the optical communication direction of the first information appliance.

4. The apparatus of claim 3, wherein the optical communication direction controlling unit adjusts and controls the direction of the optical transceiver in a direction in which light intensity is the highest at the time of adjusting and controlling the direction of the optical transceiver mounted on the first information appliance.

5. The apparatus of claim 1, further comprising:
a menu board image generating unit generating at least two types of data exchange services as a menu board type of image,
wherein the screen projecting unit projects the generated image onto the screen.

6. The apparatus of claim 5, further comprising an information appliance's location determining unit determining which data exchange service menu of at least two types of data exchange service menus the second information appliance is positioned on when the second information appliance is positioned on the projected screen.

7. The apparatus of claim 1, wherein the data exchange service providing apparatus is provided in the first information appliance.

8. The apparatus of claim 1, wherein the second information appliance includes:
a light sensing portion sensing light for projecting the screen;
a location tracking portion tracking the location of the first information appliance outputting the sensed light; and
a direction controlling portion controlling the direction of the optical transceiver to a location tracked to perform the data exchange service with the first information appliance.

9. A method for providing a data exchange service, comprising:
projecting a screen providing the data exchange service;
determining whether at least one second information appliance is positioned on the projected screen; and
controlling an optical communication direction of a first information appliance to exchange data with the second information appliance when the second information appliance is positioned on the projected screen.

10. The method of claim 9, wherein the determining of the information appliance's existence includes:
capturing the projected screen every predetermined time;
performing image processing of the captured screen; and
determining whether the second information appliance is positioned on the image processed screen.

11. The method of claim 9, wherein in the controlling of the optical communication direction, a direction of an optical transceiver mounted on the first information appliance is adjusted and controlled at the time of controlling the optical communication direction of the first information appliance.

12. The method of claim 11, wherein in the controlling of the optical communication direction, the direction of the optical transceiver is adjusted and controlled in a direction in which light intensity is the highest at the time of adjusting and controlling the direction of the optical transceiver mounted on the first information appliance.

13. The method of claim 9, further comprising:
generating at least two types of data exchange services as a menu board type of image,
wherein in the projecting of the screen, the generated image is projected onto the screen.

14. The method of claim 13, further comprising determining which data exchange service menu of at least two types of data exchange service menus the second information appliance is positioned on when the second information appliance is positioned on the projected screen.

15. The method of claim 9, wherein the data exchange service providing method is performed by the first information appliance.

16. The method of claim 9, further comprising as steps performed by the second information appliances:
sensing light for projecting the screen;
tracking the location of the first information appliance outputting the sensed light; and
controlling the direction of the optical transceiver to a location tracked to perform the data exchange service with the first information appliance.
